(19) United States
(12) Patent Application Publication
(10) Pub. No.: US 2013/0166854 A1
(43) Pub. Date: Jun. 27, 2013

(54) STORAGE APPARATUS

(71) Applicant: BUFFALO INC., Nagoya-shi (JP)

(72) Inventor: Takayuki KAKUTA, Nagoya-shi (JP)

(73) Assignee: BUFFALO INC., Nagoya-shi (JP)

(21) Appl. No.: 13/718,304

(22) Filed: Dec. 18, 2012

(30) Foreign Application Priority Data
Dec. 21, 2011 (JP) 2011-279385

(51) Int. Cl. G06F 12/00

(52) U.S. Cl. CPC G06F 12/00
USPC 711/154

(57) ABSTRACT

An information processing apparatus that performs examination-mode processing to read test data from a first special area included in a first storage device of a plurality of storage devices and write the test data to a second special area included in a second storage device of the plurality of storage devices; and stores an execution result of the examination-mode processing in a result storage area. The execution result including information that identifies the first storage device, information that identifies the second storage device and a characteristic of the transfer of the test data.

### CROSS REFERENCE TO RELATED APPLICATION

The present application claims priority to Japanese Patent Application No. 2011-279385 filed on Dec. 21, 2011, the disclosure of which is hereby incorporated by reference in its entirety.

### FIELD OF THE DISCLOSURE

The present disclosure relates to a storage apparatus including a plurality of storage drives and a control section for controlling the storage drives.

### RELATED ARTS

In the past, there has been known a storage apparatus provided with a plurality of storage drives and used for storing a large amount of data. The storage drives are each physical hardware and each provided with a user area used for storing user data. Typical examples of the storage drive are an HDD (Hard Disk Drive) and an SSD (Solid State Drive).

With the use of the storage apparatus, the storage drive deteriorates. In addition, in accordance with the deterioration of the storage drive, it is assumed that the speed at which data is written into the storage drive and/or the speed at which data is read out from the storage drive decrease. It is thus necessary to replace a storage drive which has deteriorated to a certain degree.

Assume that a storage drive has been replaced with a new one. In this case, for the purpose of evaluating the new storage drive or selecting a new storage drive proper for the speed of the data transfer, there have been proposed technologies each adopted for measuring the speed at which data is written into the storage drive or the speed at which data is read out from the storage drive. For more information on such technologies, refer to documents such as Japanese Patent Laid-open No. 2006-3945 and Japanese Patent Laid-open No. 2003-308180. With these technologies, it is possible to measure the speed at which user data is written into the user area or the speed at which user data is read out from the user area.

However, the technologies cited above are not technologies for measuring the speed at which data is written into the storage drive or the speed at which data is read out from the storage drive for the purpose of determining deterioration of the storage drive. To put it concretely, for example, with the user area being used, the speed at which data is written into the storage drive or the speed at which data is read out from the storage drive is measured. In other words, the speed at which data is written into the storage drive or the speed at which data is read out from the storage drive is measured in an environment of different loads borne by the storage drives. Thus, the technologies cited above are not proper technologies to be adopted for the purpose of determining deterioration of the storage drive.

In addition, it is conceivable that the number of problems occurred in write and read operations carried out on a storage device is counted and, as the number of problems occurred in the write and read operations exceeds a threshold value determined in advance, the storage drive is determined to have deteriorated. However, it is difficult to determine a value, at which this threshold value is to be set, in advance. To put it in detail, if the threshold value determined in advance is too large, it is quite within the bounds of possibility that the storage drive can no longer be used inevitably before the storage device is replaced with a new one. If the threshold value determined in advance is too small, on the other hand, it is quite within the bounds of possibility that the storage drive is determined to have been in a state of requiring a replacement with a new one in spite of the fact that the storage drive can still be used.

It is thus one of objects of the present disclosure addressing the problems described above to provide a storage apparatus capable of easily determining whether or not its storage drive has deteriorated.

### SUMMARY OF THE DISCLOSURE

According to one exemplary embodiment, the disclosure is directed to an information processing apparatus that performs examination-mode processing to read test data from a first special area included in a first storage device of a plurality of storage devices and write the test data to a second special area included in a second storage device of the plurality of storage devices; and stores an execution result of the examination-mode processing in a result storage area. The execution result including information that identifies the first storage device, information that identifies the second storage device and a characteristic of the transfer of the test data.

### BRIEF DESCRIPTION OF DRAWINGS

FIG. 1 is a diagram showing a storage apparatus according to an embodiment of the present disclosure;

FIG. 2 is a diagram showing a storage drive according to the embodiment of the present disclosure;

FIG. 3 is a block diagram showing the storage apparatus according to the embodiment of the present disclosure;

FIG. 4 is a diagram showing a storage area of the storage drive according to the embodiment of the present disclosure;

FIG. 5 shows a flowchart representing examination-mode processing according to the embodiment of the present disclosure;

FIG. 6 shows a flowchart representing examination-mode processing according to the embodiment of the present disclosure;

FIG. 7 shows a flowchart representing examination-mode processing according to the embodiment of the present disclosure;

FIG. 8 shows a flowchart representing examination-mode processing according to an aspect of the embodiment of the present disclosure;

FIG. 9 is a diagram showing a typical display of results of executing examination- mode processing according to an aspect of the embodiment of the present disclosure; and

FIG. 10 is an explanatory diagram showing a table to be referred to in description of determination as to whether a problem exists in accordance with another aspect of the embodiment of the present disclosure.

### DESCRIPTION OF THE DISCLOSURE

A storage apparatus according to an embodiment of the present disclosure is explained by referring to the diagrams as follows. It is to be noted that, in the following description with reference to the diagrams, sections having configurations identical with each other are denoted by the same reference numeral.

However, the diagrams are model diagrams in which ratios of dimensions and the like are different from the actual ones. That is to say, a concrete dimension shown in a diagram should be found by referring to description explaining the diagram. In addition, the diagrams include portions with different dimensional relations and different dimensional ratios.

A storage apparatus according to an embodiment of the present disclosure includes a plurality of storage drives and a control section for controlling the storage drives. Each of the storage drives has a user area used for storing user data and a special area other than the user area. The control section has an examination mode in which test data read out from the special area included in a first storage drive selected among the storage drives is written into the special area included in a second storage drive selected among the storage drives in a transfer. The control section stores a result of execution of the examination-mode processing in a result storage area. The execution result includes information used for identifying the first storage drive, information used for identifying the second storage drive and a characteristic of the transfer of the test data.

This embodiment has an examination mode in which the control section examines a characteristic of a transfer of test data. In addition, in the examination mode, the control section makes use of a special area other than the user area. To be more specific, the control section reads out test data from the special area of the first storage drive and writes the test data into the special area of the second storage drive.

Thus, the control section examines the transfer characteristics in a state wherein a load borne by the first storage drive is the same as that of the second storage drive. In addition, on the basis of the examination-mode execution result stored in the result storage area, it is possible to easily determine whether or not a storage drive has deteriorated.

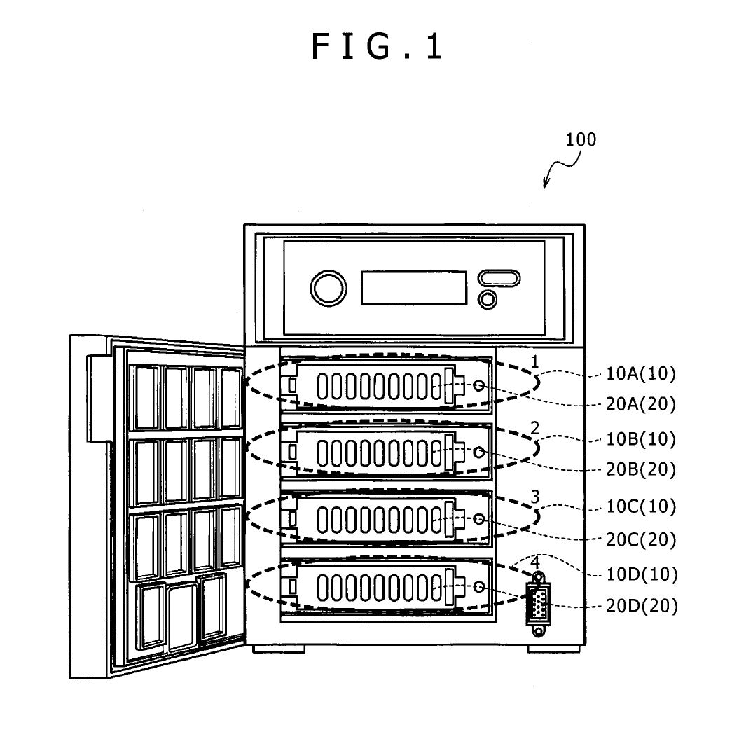

First of all, an outline of a storage apparatus 100 according to an embodiment of the present disclosure is explained as follows. FIG. 1 is a diagram showing an external appearance of the storage apparatus 100 according to the embodiment of the present disclosure.

As shown in FIG. 1, the storage apparatus 100 according to the embodiment includes a plurality of storage drives 10 and the same plurality of drive bays 20.

The storage drives 10 are each physical hardware and each provided with a user area used for storing user data. Typical examples of the storage drive 10 are an HDD (Hard Disk Drive) and an SSD (Solid State Drive). In this embodiment, the storage apparatus 100 includes storage drives 10A to 10D. However, the number of storage drives 10 is by no means limited to four.

The drive bay 20 is a bay for accommodating a storage drive 10. The drive bay 20 typically has a connector connected to a pin group provided on the storage drive 10. In a first embodiment, the storage apparatus 100 includes storage bays 20A to 20D. However, the number of drive bays 20 is by no means limited to four.

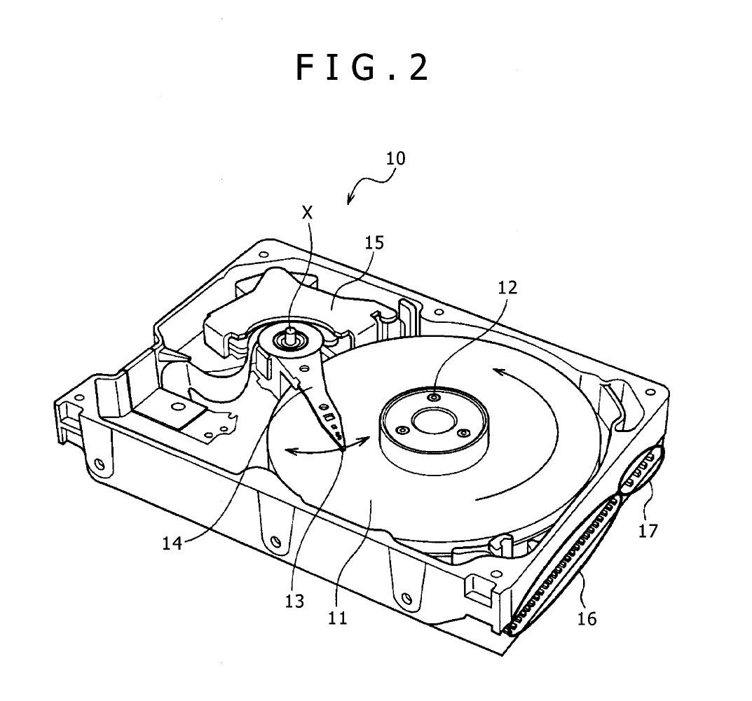

In the following description, a storage drive 10 according to the first embodiment is explained. FIG. 2 is a diagram showing the storage drive 10 according to the first embodiment. In this case, the storage drive 10 is an HDD which is a typical storage drive 10.

As shown in FIG. 2, the storage drive 10 includes a platter 11, a spindle motor 12, a head 13, a swing arm 14, an actuator 15, interface pins 16 and power-supply pins 17.

The platter 11 is a circular disk used for recording data. A magnetic material is coated on the surface of the platter 11. On the surface of the magnetic material, a lubricated film (liner) is provided. Data can be recorded on one surface of the platter 11 or both the surfaces of the platter 11. The storage capacity of the platter 11 is determined by, among others, the recording density of data recorded on the platter 11. The storage capacity of the platter 11 is also referred to as a platter storage capacity.

The spindle motor 12 is a motor for rotating the platter 11. To put it in detail, the spindle motor 12 rotates the platter 11 at typically 7,200 rpm (revolutions per minute).

The head 13 is a magnetic head for writing data onto the platter 11 and reading out data from the platter 11.

The swing arm 14 is configured to be able to rotate around a rotation axis X serving as the center of the rotation. The head 13 is provided on the edge of the swing arm 14. While the swing arm 14 is rotating, the position of the head 13 is adjusted in the radial direction of the platter 11.

The actuator 15 is a driving section for driving the swing arm 14. The actuator 15 is typically a voice coil motor.

The interface pins 16 are connected to a connector provided on the drive bay 20. Data written by the head 13 into the platter 11 is output by the storage apparatus 100 to the storage drive 10 by way of the interface pins 16. On the other hand, data read out by the head 13 from the platter 11 is output by the storage drive 10 to the storage apparatus 100 by way of the interface pins 16.

The power-supply pins 17 are connected to a connector provided on the drive bay 20. Power for driving the storage drive 10 is supplied from the storage apparatus 100 to the storage drive 10 by way of the power-supply pins 17.

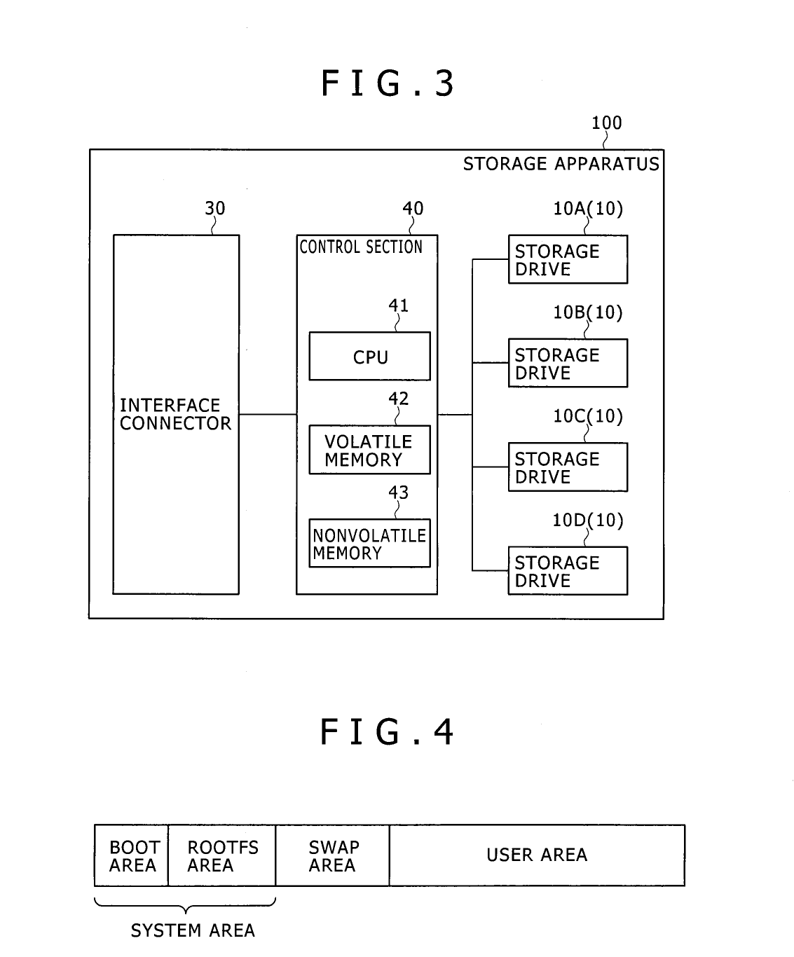

Details of the storage apparatus 100 according to this embodiment are explained as follows. FIG. 3 is a block diagram showing the storage apparatus 100 according to the embodiment.

As shown in FIG. 3, the storage apparatus 100 includes a plurality of storage drives 10, an interface connector 30 and a control section 40. It is to be noted that the drive bays 20 described above are not shown in FIG. 3.

In this typical embodiment, as shown in FIG. 4, each of the storage drives 10 has a system area, a swap area and a user area.

The system area is an area used for storing system data. The system area includes a boot area and a rootfs area. The boot area is an area used for storing data required in activation of an OS (Operating System) provided in the control section 40. On the other hand, the rootfs area is an area used for storing a file system of the storage drive 10. To put it in detail, the rootfs area is an area used for storing a root file system which is a hierarchical directory structure including a root directory.

The swap area is an area used as a save destination of data stored temporarily in a volatile memory 42 to be described later. In the first embodiment, the swap area is a typical example of the special area used in the examination mode for examining the storage drive 10.

The user area is an area used for storing user data. That is to say, user data written by an external apparatus such as a personal computer into the storage apparatus 100 is stored in the user area. In addition, the user area is used for storing user data to be read out by an external apparatus such as a personal computer.

The interface connector 30 is a connector for connecting the storage apparatus 100 to an external apparatus such as a personal computer or a router. The interface connector 30 is typically a USB connector or an Ethernet (registered trademark) connector. The storage apparatus 100 receives data from the external apparatus through the interface connector 30 and transmits data to the external apparatus through the interface connector 30.

The control section 40 controls the storage drives 10. To put it concretely, the control section 40 includes a CPU 41, a volatile memory 42 and a nonvolatile memory 43. The volatile memory 42 is a volatile semiconductor memory such as a DRAM. The volatile memory 42 is used for temporarily storing data required in operations carried out by the control section 40 to control the storage drives 10. On the other hand, the nonvolatile memory 43 is a nonvolatile semiconductor memory (such as a flash memory) used for storing an OS (Operating System) and programs to be executed to carry out various kinds of processing. The nonvolatile memory is one example of a computer-readable medium, which may be accessed by the CPU 41 to execute the OS and programs stored therein.

In this embodiment, the control section 40 carries out processing in the examination mode for examining the storage drives 10 in accordance with the programs stored in the nonvolatile memory 43. To put it in detail, it is the CPU 41 which carries out the processing in the examination mode. In the first place, in the processing carried out in the examination mode, in order to examine the characteristics of a data transfer from a first storage drive to a second storage drive, the control section 40 writes test data read out from the swap area provided in the first storage drive into the swap area provided in the second storage drive.

The result of the execution of the processing in the examination mode includes information used for identifying the first storage drive, information used for identifying the second storage drive and information representing a characteristic of the transfer of the test data.

In this case, the information representing a characteristic of the transfer of the test data may be the speed of the transfer of the test data from the first storage drive to the second storage drive. As an alternative, the information representing a characteristic of the transfer of the test data may be the time it takes to transfer the test data from the first storage drive to the second storage drive. It is to be noted that, if the information representing a characteristic of the transfer of the test data is the speed of the transfer, the information may be expressed as a quotient obtained by dividing the amount of the test data by the time it takes to transfer the test data from the first storage drive to the second storage drive. Typically, the amount of the test data is expressed in terms of MBs (megabytes) whereas the time it takes to transfer the test data from the first storage drive to the second storage drive is expressed in terms of seconds. Thus, in this case, the quotient is expressed in terms of MBs/s.

In addition, the start time of an operation carried out to transfer the test data from the first storage drive to the second storage drive is a time at which the examination of the transfer speed is started.

On the other hand, the end time of the operation carried out to transfer the test data from the first storage drive to the second storage drive is typically a time at which the examination of the transfer speed is ended.

It is to be noted that a read command issued to the first storage drive is a command specifying an area determined in advance and requesting an operation to read out test data from the predetermined area which begins with the head sector in the swap area and ends with the tail sector in the swap area. On the other hand, a write command issued to the second storage drive is a command specifying an area determined in advance and requesting an operation to write the test data into the predetermined area which begins with the head sector in the swap area and ends with the tail sector in the swap area.

In the second place, the control section 40 stores the result of the execution of the processing carried out in the examination mode in a result storage area. To put it in detail, it is CPU 41 stores the result of the execution of the processing carried out in the examination mode in a result storage area. Typically, the control section 40 displays the execution result stored in the result storage area on a display unit provided in an external apparatus such as a personal computer. To put it in detail, the external apparatus (such as a personal computer) capable of making an access to the storage apparatus 100 executes special software or other software such as a browser in order to read out the execution result stored in the result storage area and display the execution result read out from the result storage area on the display unit.

The result storage area is provided in the control section 40. Typically, the result storage area is provided in the nonvolatile memory 43 included in the control section 40. As an alternative, the result storage area may be provided in at least one of the storage drives 10. In addition, the result storage area may be provided in each of the storage drives 10. If the result storage area is provided in each of the storage drives 10, the result of execution of the examination mode is stored in each of the storage drives 10.

In this embodiment, it is desirable that the control section 40 stores test data in the swap area provided in the first storage drive prior to an operation carried out to read out the test data from the swap area. That is to say, the control section 40 desirably carries out the processing of the examination mode after newly writing the test data into the swap area.

In addition, in this embodiment, it is desirable that the control section 40 carries out the processing of the examination mode without mounting the user area and the swap area. That is to say, it is desirable that the control section 40 carries out the processing of the examination mode in a state in which the file system has not been recognized by the OS, that is, in a state in which the user area and the swap area have not been mounted. It is to be noted that the control section 40 knows the address of the head sector of the swap area.

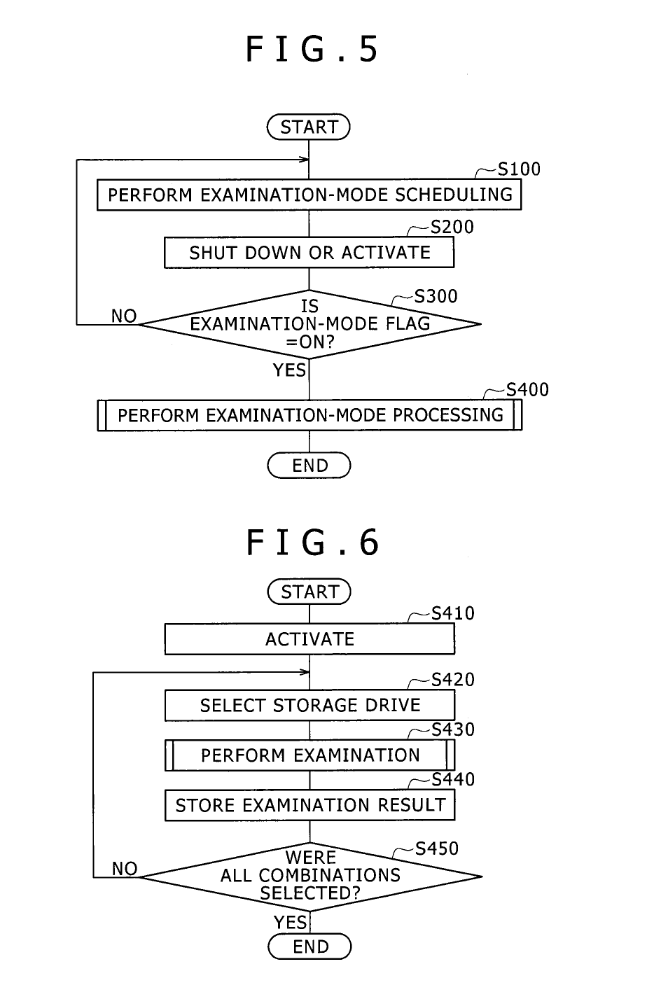

The processing carried out in the examination mode in this embodiment is explained as follows. FIGS. 5 to 7 each show a flowchart representing the processing carried out in the examination mode in accordance with the embodiment.

As shown in FIG. 5, at a step 100, an external apparatus capable of making an access to the storage apparatus 100 executes special software or other software such as a browser in order to carry out scheduling of the examination mode. For example, the external apparatus carries out scheduling of the examination mode so that the processing of the examination mode is performed at a shutdown time of the storage apparatus 100 or an activation time of the storage apparatus 100.

In this case, the storage apparatus 100 sets an examination-mode flag in an ON state. The examination-mode flag is a flag for indicating whether or not the processing of the examination mode is to be carried out. If the examination-mode flag has been put in an ON state, the processing of the examination mode is carried out. If the examination-mode flag has not been put in an OFF state, on the other hand, the processing of the examination mode is not carried out.

At a step 200, the storage apparatus 100 is shut down or activated.

At a step 300, the storage apparatus 100 determines whether or not the examination-mode flag has been put in an ON state. If the determination result is YES, the storage apparatus 100 continues the processing represented by the flowchart to a step 400. If the determination result is NO, on the other hand, the storage apparatus 100 goes back to the processing of the step 100.

At the step 400, the storage apparatus 100 carries out the processing of the examination mode in accordance with the flowchart shown in FIG. 6. To put it concretely, as shown in FIG. 6, at a step 410, the storage apparatus 100 activates the storage drives 10. In this case, the storage apparatus 100 activates the storage drives 10 without mounting the user area and the swap area.

At a step 420, the storage apparatus 100 selects object storage drives from the storage drives 10. The object storage drives are the first storage drive and the second storage drive. The first storage drive is a storage drive 10 from which test data is to be read out. On the other hand, the second storage drive is a storage drive 10 into which the test data read out from the first storage drive is to be written.

In this case, prior to the execution of examination of a transfer speed, the storage apparatus 100 stores the test data into the swap area provided in the first storage drive. This swap area is used as the special area.

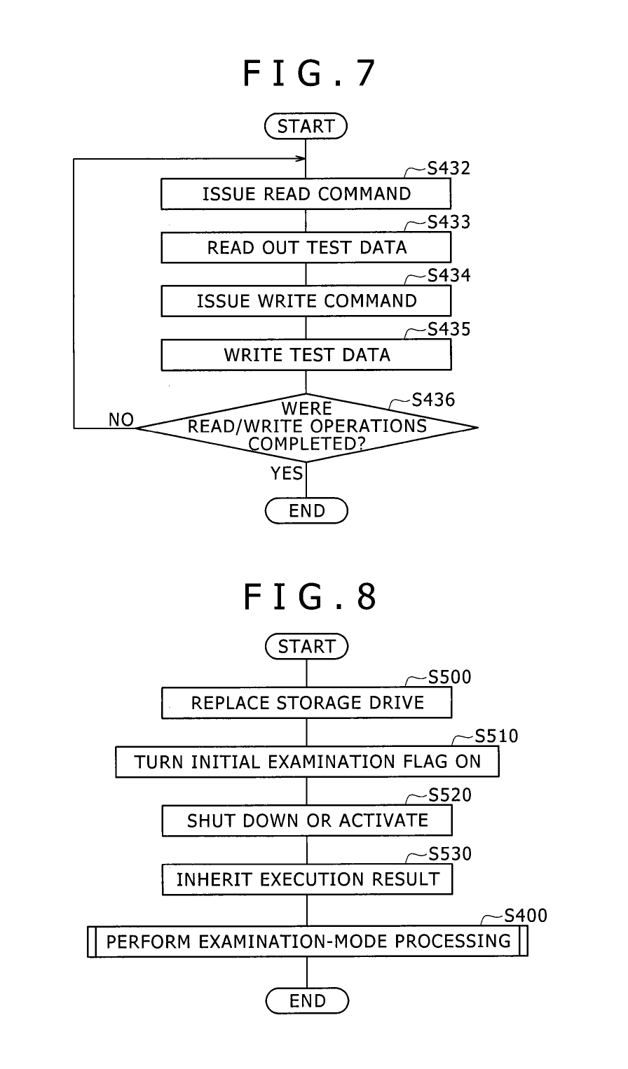

At a step 430, the storage apparatus 100 carries out the examination of the transfer speed in accordance with the flowchart shown in FIG. 7. To put it in detail, as shown in FIG. 7, at a step 432, the storage apparatus 100 issues a read command to the first storage drive. The read command issued to the first storage drive is a command specifying an area determined in advance as the swap area included in the first storage drive and requesting an operation to read out test data from the predetermined area which begins with the head sector in the swap area and ends with the tail sector in the swap area.

At a step 433, the storage apparatus 100 reads out the test data from the swap area included in the first storage drive.

At a step 434, the storage apparatus 100 issues a write command to the second storage drive. The write command issued to the second storage drive is a command specifying an area determined in advance as the swap area included in the first storage drive and requesting an operation to write the test data into the predetermined area which begins with the head sector in the swap area and ends with the tail sector in the swap area.

At a step 435, the storage apparatus 100 writes the test data into the swap area included in the second storage drive.

At a step 436, the storage apparatus 100 determines whether or not the operation carried out to read out the test data from the swap area included in the first storage drive and the operation carried out to write the test data into the swap area included in the second storage drive have been completed. In other words, the storage apparatus 100 determines whether or not an operation carried out to transfer the test data from the swap area included in the first storage drive to the swap area included in the second storage drive has been completed.

If the transfer operation described above has been completed, the flow of the processing goes back to a step 440 of the flowchart shown in FIG. 6. At this step, the storage apparatus 100 stores a result of the execution of the examination mode in a result storage area. The execution result stored by the storage apparatus 100 in the result storage area includes information used for identifying the first storage drive, information used for identifying the second storage drive and a characteristic of the transfer of the test data. The characteristic of the transfer of the test data is the characteristic of a transfer of the test data from the first storage drive to the second storage drive. To put it concretely, the characteristic of the transfer of the test data is the difference between a transfer start time and a transfer end time.

In this case, the transfer start time is a point of time at which the transfer speed examination carried out at the step 430 is started. The transfer start time is acquired from a timer chip not shown in the figures and stored in a memory. By the same token, the transfer end time is a point of time at which the transfer speed examination carried out at the step 430 is terminated. The transfer end time is acquired from a timer chip not shown in the figures and stored in a memory.

At a step 450, the storage apparatus 100 determines whether or not all pairs each consisting of two storage drives 10 have been selected. If the determination result is YES, the storage apparatus 100 terminates the processing sequence. If the determination result is NO, on the other hand, the storage apparatus 100 goes back to the processing of step 420. If the storage apparatus 100 goes back to the processing of step 420, the storage apparatus 100 selects at least another one of the storage drives 10 to be used as a new first or second storage drive. As described before, the first storage drive is a storage drive 10 from which test data is to be read out. On the other hand, the second storage drive is a storage drive 10 into which the test data read out from the first storage drive is to be written.

In the first aspect of the embodiment, the control section 40 carries out the processing of the examination mode for examining the characteristic of the transfer of test data. In addition, in the processing of the examination mode, the control section 40 carries out an operation to read out data from a special area other than the user area and an operation to write data into such a special area.

Thus, the characteristic of the transfer of test data is examined in a state wherein all the storage drives 10 bear the same load. In addition, on the basis of an examination-mode execution result stored in a result storage area, it is possible to determine whether or not a storage drive 10 has deteriorated or degree of deterioration.

An aspect of the embodiment is explained as follows. The following description focuses mainly on differences from the above description.

The following description explains examination-mode processing, which is carried out when a storage drive 10 is replaced, and a typical display of an examination- mode execution result.

First of all, the following description explains examination-mode processing which is carried out when a storage drive 10 is replaced. As shown in FIG. 8, at a step 500, in a drive bay 20 determined in advance, the storage drive 10 is replaced.

At a step 510, an external apparatus capable of making an access to the storage apparatus 100 executes special software or other software such as a browser in order to set an initial examination flag in an ON state. The initial examination flag is a flag indicating whether or not the storage drive 10 has been replaced. If the storage drive 10 has been replaced, the initial examination flag is set in an ON state. If the storage drive 10 has not been replaced, on the other hand, the initial examination flag is set in an OFF state.

At a step 520, the storage apparatus 100 is shut down or activated.

At a step 530, the storage apparatus 100 keeps the stored result of the execution of the examination-mode processing carried out for the storage drive 10 in the predetermined drive bay 20 prior to the replacement of the storage drive 10 as it is. That is to say, the storage apparatus 100 does not erase the result of the execution of the examination-mode processing from the result storage area. Instead, the storage apparatus 100 keeps the stored result of the execution of the examination-mode processing carried out for the storage drive 10 in the predetermined drive bay 20 prior to the replacement of the storage drive 10 as a result of the execution of the examination-mode processing carried out for the storage drive 10 in the predetermined drive bay 20 after the replacement of the storage drive 10.

At a step 400, the storage apparatus 100 carries out the examination-mode processing. It is to be noted that the examination-mode processing carried out at the step 400 is the same as the examination-mode processing explained before. Thus, it is not necessary to repeat the explanation of the examination-mode processing.

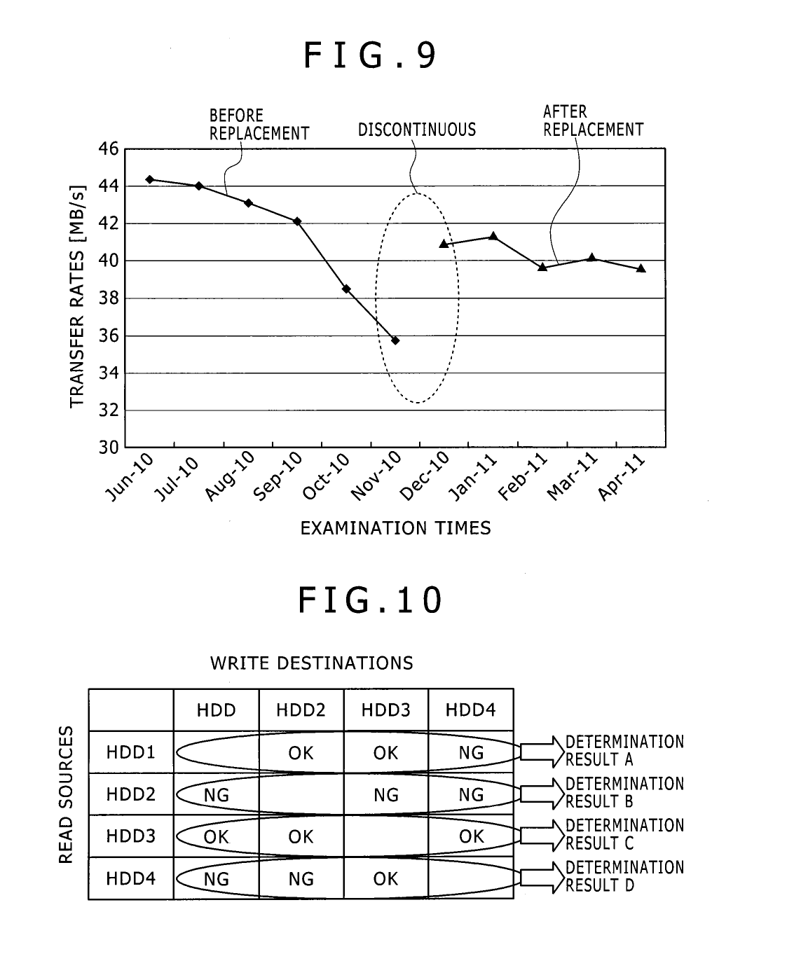

In such a case, as shown in FIG. 9, the external apparatus (such as a personal computer) capable of making an access to the storage apparatus 100 displays the result of the execution of the examination-mode processing carried out for the storage drive 10 prior to the replacement of the storage drive 10 and the result of the execution of the examination-mode processing carried out for the storage drive 10 after the replacement of the storage drive 10 on a display unit in a distinguishable format. That is to say, as shown in FIG. 9, the external apparatus displays a typical graph on the display unit to represent the results of the execution of the examination-mode processing before and after the replacement of the storage drive 10 so that it is obvious from the graph that the storage drive 10 has been replaced. The graph is cut into a line representing a state prior to the replacement of the storage drive 10 and a line representing a state after the replacement of the storage drive 10.

As shown in FIG. 9, the result of the execution of the examination-mode processing is displayed as a polygonal-line graph. It is to be noted, however, that a result of the execution of the examination-mode processing does not have to be displayed as a polygonal-line graph.

In addition, another aspect of the embodiment is explained as follows.

In the other aspect, on the basis of combinations of results of the execution of the examination-mode processing, the storage apparatus 100 (or the control section 40) generates information on problematic states of the storage drives 10. The information on problematic states typically includes information indicating whether or not a problem has been raised and, in case a problem has been raised, information on the cause of the problem or information indicating a storage drive 10 raising the problem. It is to be noted that the problem is a write problem or a read problem. The write or read problem is mainly a problem raised in an operation to transfer data read out from a data read source to a data write destination. The data read source is the first storage drive 10 from which test data is to be read out whereas the data write destination is the second storage drive 10 into which test data is to be written.

In a typical configuration in the other aspect, the storage drives 10 are four HDDs referred to as HDD1 to HDD4 respectively. This typical configuration is explained by referring to FIG. 10 as follows. It is to be noted that, in FIG. 10, a variety of phenomena are summarized in a table in order to make the explanation simple. That is to say, the phenomena summarized in the table do not occur simultaneously. In addition, in FIG. 10, notation OK means that the transfer characteristic is normal whereas notation NG means that the transfer characteristic has deteriorated. As described above, the transfer characteristic is the characteristic of a transfer of test data.

It is to be noted that, in FIG. 10, the leftmost column shows the storage drives 10 each serving as a data read source whereas the uppermost row shows the storage drives 10 each serving as a data write destination. In addition, the following explanation of the typical configuration in the aspect of this embodiment can also be applied to a configuration in which the storage apparatus 100 includes three storage drives 10 or at least five storage drives 10.

To put it concretely, as shown in FIG. 10, let us consider a case in which the hard disk HDD1 serves as a data read source. In this case, the transfer characteristic is normal if the hard disk HDD2 or HDD3 serves as a data write destination. However, the transfer characteristic is deteriorated only if the hard disk HDD4 serves as a data write destination. In such a case, the storage apparatus 100 determines that a problem raised in an operation to write data into the hard disk HDD4 is the cause of the deterioration problem. At that time, the storage apparatus 100 produces a determination result A. As described above, if the number of HDDs each serving as a data write destination and each raising a detected transfer-characteristic deterioration problem is one, the storage apparatus 100 determines that a write problem has been raised in the data write destination HDD raising the detected transfer-characteristic deterioration problem.

Let us assume that the hard disk HDD2 serves as a data read source while the hard disks HDD1, HDD3 and HDD4 each serve as a data write destination. Let us also consider a case in which deteriorations of all transfer characteristics are detected. In such a case, the storage apparatus 100 determines that a problem raised in an operation to read out data from the hard disk HDD2 is the cause of the deterioration problems. At that time, the storage apparatus 100 produces a determination result B. As described above, if the transfer-characteristic deterioration problem is raised in all the HDDs each serving as a data write destination, the storage apparatus 100 determines that a read problem has been raised in the HDD serving as the data read source.

Let us assume that the hard disk HDD3 serves as a data read source while the hard disks HDD1, HDD2 and HDD4 each serve as a data write destination. Let us also consider a case in which no deteriorations of transfer characteristics are detected. In such a case, the storage apparatus 100 determines that, in an operation to read out data from the hard disk HDD3, no transfer-characteristic problem is raised. At that time, the storage apparatus 100 produces a determination result C. As described above, if no transfer-characteristic deterioration problem is raised in all the HDDs each serving as a data write destination, the storage apparatus 100 determines that no problem has been raised.

Let us consider a case in which the hard disk HDD4 serves as a data read source. In this case, the transfer characteristic is deteriorated if the hard disk HDD1 or HDD2 serves as a data write destination. However, no transfer-characteristic deterioration is detected if the hard disk HDD3 serves as a data write destination. In such a case, the storage apparatus 100 determines that a problem other than problems raised in data read and write operations has been raised. A typical example of the other problem is a problem caused by an environment in which the storage apparatus 100 has been installed. At that time, the storage apparatus 100 produces a determination result D. As described above, in spite of the fact that a plurality of HDDs each serving as a data write destination each raise a detected transfer-characteristic deterioration problem, the storage apparatus 100 determines that a problem other than problems raised in data read and write operations has been raised provided that there is an HDD which serves as a data write destination and generates no transfer-characteristic deterioration.

It is to be noted that, in this case, the storage apparatus 100 may store the previous transfer characteristic of the examination-mode processing in a memory. Then, the storage apparatus 100 computes the difference between the previous transfer characteristic of the examination-mode processing and the current transfer characteristic of the examination- mode processing. If the difference is equal to or greater than a threshold value determined in advance, the storage apparatus 100 determines that the transfer characteristic of examination-mode processing has deteriorated. As an alternative, if the current transfer characteristic of the examination-mode processing is equal to or smaller than a threshold value determined in advance, the storage apparatus 100 determines that the transfer characteristic of examination-mode processing has deteriorated.

The embodiments of the present disclosure have been described above. However, each description and each diagram which explain only part of the disclosure are not to be interpreted as limitations imposed on the present disclosure. It is probably obvious that, from this disclosure, a person skilled in the art is capable of creating a variety of substitutes for the embodiments, a variety of other implementations of the present disclosure and a variety of operation technologies.

In the embodiments, the swap area is used as the special area. However, implementations of the present disclosure are by no means limited to the embodiments. For example, any area other than the swap area can also be used as the special area as long as the area other than the swap area is not the user area.

In the embodiments, the transfer characteristic of test data is a characteristic related to a transfer of the test data from a first storage drive to a second storage drive. However, the transfer characteristic of the test data may also be a characteristic related to an operation carried out to read out the test data from a first storage drive. In such a case, the read end time of the test data is a time at which a transfer of the test data from the swap area included in the first storage drive to the volatile memory 42 is ended. As an alternative, the transfer characteristic of the test data may also be a characteristic related to an operation carried out to write the test data into a second storage drive. In such a case, the write end time of the test data is a time at which a transfer of the test data from the volatile memory 42 to the swap area included in the second storage drive is ended.

In the embodiments, a transfer period of test data is a period between a transfer start time and a transfer end time. In this case, the transfer start time is the start time of the step 430 at which the transfer speed is examined. On the other hand, the transfer end time is the end time of the step 430 at which the transfer speed is examined. However, the embodiments do not have to adopt such a transfer period, such a transfer start time and such a transfer end time. For example, the transfer start time can be a read start time which is a time at which the initial read command is issued to the first storage drive. As an alternative, the transfer end time can be a write end time which is a time at which the last write command is issued to the second storage drive.

The description of the embodiments does not mention a configuration in which the result storage area is included in the nonvolatile memory 43. In the case of this configuration, it is desirable that the control section 40 mounts the result storage area in the course of the processing of the examination mode.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
a plurality of storage devices each including a user area that stores user data and a special area that is different from the user area; and
a control section that
performing examination-mode processing to read out test data from a first special area included in a first storage device of the plurality of storage devices and write the test data to a second special area included in a second storage device of the plurality of storage devices; and
stores an execution result of the examination-mode processing in a result storage area, wherein
the execution result includes information that identifies the first storage device, information that identifies the second storage device and a characteristic of the transfer of the test data.

2. The information processing apparatus of claim 1, wherein
the special area included in each of the plurality of storage devices is a swap area configured to temporarily store data.

3. The information processing apparatus of claim 1, wherein
the control section writes the test data to the first special area of the first storage device before reading out the test data from the first special area of the first storage device.

4. The information processing apparatus of claim 1, wherein
the control section carries out the examination-mode processing without mounting the user area and the special area.

5. The information processing apparatus of claim 1, wherein
a first execution result corresponding to a pre-replacement storage device and a second execution result corresponding to a post-replacement storage device are displayed in a distinguishable format, when the pre-replacement storage device included in the plurality of storage devices is replaced with the post-replacement storage device.

6. The information processing apparatus of claim 1, wherein
the plurality of storage devices includes at least three storage devices.

7. The information processing apparatus of claim 6, wherein
the control section generates diagnostic information based on combinations of execution results corresponding to the at least three storage devices.

8. The information processing apparatus of claim 1, wherein
the result storage area is provided in at least one of the plurality of storage devices.

9. The information processing apparatus of claim 1, wherein
the result storage area is provided in the control section.

10. A method performed by an information processing apparatus, the method comprising:
performing examination-mode processing to read test data from a first special area included in a first storage device of a plurality of storage devices and write the test data to a second special area included in a second storage device of the plurality of storage devices; and
storing an execution result of the examination-mode processing in a result storage area, wherein
the execution result includes information that identifies the first storage device, information that identifies the second storage device and a characteristic of the transfer of the test data.

11. A non-transitory computer-readable medium including computer-program instructions, which when executed by an information processing apparatus, cause the information processing apparatus to perform a process comprising:
performing examination-mode processing to read test data from a first special area included in a first storage device of a plurality of storage devices and write the test data to a second special area included in a second storage device of the plurality of storage devices; and
storing an execution result of the examination-mode processing in a result storage area, wherein
the execution result includes information that identifies the first storage device, information that identifies the second storage device and a characteristic of the transfer of the test data.
